(19) United States
(12) Patent Application Publication
(10) Pub. No.: US 2013/0126669 A1
(43) Pub. Date: May 23, 2013

(54) ELECTRIC DRIVE DEVICE FOR AN AIRCRAFT

(71) Applicants: Jens Hamann, Furth (DE); Markus Klöpzig, Ebermannstadt (DE); Olaf Körner, Nurnberg (DE)

(72) Inventors: Jens Hamann, Furth (DE); Markus Klöpzig, Ebermannstadt (DE); Olaf Körner, Nurnberg (DE)

(73) Assignee: Siemens Aktiengesellschaft, Munchen (DE)

(21) Appl. No.: 13/813,069

(22) PCT Filed: Jul. 22, 2011
(86) PCT No.: PCT/EP2011/062633

§ 371 Date: Jan. 29, 2013

(30) Foreign Application Priority Data
Jul. 30, 2010 (EP) 10171433.5

(51) Int. Cl. B64D 35/02

(52) U.S. Cl. CPC B64D 35/02
USPC 244/60

(57) ABSTRACT

The invention relates to an electric drive (1) for an aircraft, especially for a helicopter (20) comprising at least one rotor (23) that is directly driven by a dynamoelectric machine (2). The dynamoelectric machine (2) is embodied in a duplex arrangement, a rotor (6) arranged in an air gap (12) comprising permanent magnets (13) on a carrier device (14), and the stators (4, 5) of the dynamoelectric machine (2) and/or the rotor (6) comprising coolant. A planetary gear (3) is especially provided between the driven rotor and the dynamoelectric machine (2), preferably in the axial extension of the dynamoelectric machine (2).

The invention relates to an electric drive device for an aircraft, especially a helicopter with at least one rotor.

A rotor in this case is the turning (rotating) part of a machine, for example of a helicopter or of a propeller-driven aircraft. In such cases a rotor is understood as both the rotor blades and also the rotor head to which these rotor blades are attached, and also the shaft that rotates in its bearing along with the rotor.

Rotors which drive aircraft are also referred to as airscrews or propellers. With helicopters in particular a comparatively high specific power, i.e. kW/kg, is the desired objective in order to increase the payload of the helicopter.

A duplex electric motor is known from DE 39 15 526 A1 in which rotation is imparted to a hollow rotor from outside to inside and in this way comparatively higher power is to be achieved in relation to conventional electric motors.

A high-torque electric motor is known from DE 198 56 647 A1 which is constructed as a high-pole, permanent magnet-excited electric motor and has a hollow cylindrical rotor made of soft iron which is occupied on both sides by permanent magnets and is disposed coaxially between an outer and an inner stator and is connected rotatably to a shaft supported in the machine housing.

These types of duplex configuration are known from a plurality of publications. For example from CN 1909340 A, CN 201113670 Y, WO 2007/024224 A1 or from JP 3237295 A.

A wind generator in a duplex arrangement and a gear unit coupled thereto is known from EP 1 612 415 A2.

A helicopter with double rotors, the rotors of which are driven by electric motors, is known from WO 09/143669 A1.

An electric drive system with a rotor ring on which magnets are disposed is known from WO 2010/029113 A2, which serves to drive air sport devices.

A starter/generator for aircraft in a duplex arrangement is known from EP 1 931 015 A2.

A drive device for an aircraft is known from U.S. Pat. No. 4,259,809, in which a drive moves a propeller via a planetary gear.

The disadvantage of the previously known embodiments of the motors or the drives for helicopters is that existing concepts, especially for helicopters, are only suitable to a limited extent because of the complex constructions and thus the weight of the drive.

Using this as its starting point, the underlying object of the invention is to create a drive for a rotor of an aircraft, especially for a helicopter, which outputs a comparatively high power for a low inherent weight of its drive.

The desired object is achieved by an electrical drive for a aircraft, especially for a helicopter with at least one rotor, which is driven directly by a dynamoelectric machine, wherein
the dynamoelectric machine is designed in a duplex arrangement, wherein a rotor located in an air gap features permanent magnets on a carrier facility, wherein the stators of the dynamoelectric machine and/or the rotor have cooling means,
a planetary drive in particular is present between driven rotor and dynamoelectric machine, preferably in an axial extension of the dynamoelectric machine.

A dynamoelectric machine—an electric motor—in a duplex arrangement and especially a planetary gear are disposed inventively in a common housing as direct drive of a rotor of a helicopter or of another aircraft, such as a single-engine or multi-engine propeller-driven aircraft for example. The planetary gear has joint bearings with the electric motor. This reduces the number of bearing points and thus leads to a compact drive.

The size of the electric motor is determined by the torque required. Direct-drive, especially torque motors, are especially suitable for this purpose. In order to obtain a highly-utilized drive system it is necessary to operate the motor at high speed, especially at a speed of >10000 rpm. It is thus especially advantageous to combine a torque motor in a compact design with a planetary gear in order on the one hand to obtain the required torque and on the other hand the required speed, especially for a rotor drive of a helicopter.

In order to additionally increase utilization of the electric drive the electric motor is embodied in a duplex arrangement. In this case a rotor is disposed in an air gap between an outer stator and an inner stator. The rotor is disposed between the two.

In order to now increase the utilization, at least the outer stator and also the inner stator, for greater demands on the utilization, is cooled with a liquid, especially oil. The oil is also needed for the lubrication of the planetary gear. Oil is an electrical insulator and can thus also circulate directly around the winding of the stator. Cooling by oil is thus very effective since the heat on the one hand is picked up directly at the heat source and the oil can also advantageously at the same time form the lubricant for the planetary gear. Thus only one cooling circuit is necessary which encloses the stators and the gears. The oil is cooled again by heat exchangers in and/or on the aircraft. The stators are thus provided with an encapsulation which surrounds at least the winding of the stators or the entire stator including winding, a laminated core and winding head. The rotor equipped with permanent magnets is cooled by conveying air through the air gap of the electric motor.

In a further embodiment the rotor rotates in the vacuum of the electric motor in order to avoid the air friction losses.

In order to further reduce the losses, especially the eddy current losses in the rotor, the permanent magnets are structured in layers.

The winding of the stators in this case is designed as a poly-phase winding, advantageously as a three-phase winding respectively.

The rotor is embodied hollow since the inner stator is located in its interior. Preferably this hollow shape represents a bell shape which serves as a carrier facility for permanent magnets, which is especially embodied in the area of the active part of the inner and outer stator as a hollow cylinder. In such cases the permanent magnets are disposed both on the outer jacket surface and also on the inner jacket surface of the hollow cylinder. Advantageously the bell on which the permanent magnets are disposed is divided into two, which for example significantly facilitates the installation of the rotor between internal and external stator.

Permanent magnets are provided on the circumferential surface of a carrier device or in pockets of the carrier device of the rotor running axially, which consists of soft iron or has aramids in the form of fibers. The carrier device has inner permanent magnets, i.e. assigned electromagnetically to an inner stator, and also outer permanent magnets, i.e. assigned electromagnetically to an outer stator.

In order to further increase the efficiency of the entire drive arrangements of electric motor and planetary gear and produce a less maintenance-intensive design, advantageously at least one bearing is embodied as a magnetic bearing.

The features presented now produce a drive of the rotor for a helicopter with a specific power-to-weight ratio of 8 KW/kg.

The invention and also further advantageous embodiments of the invention are described in greater detail on the basis of an exemplary embodiment, in which;

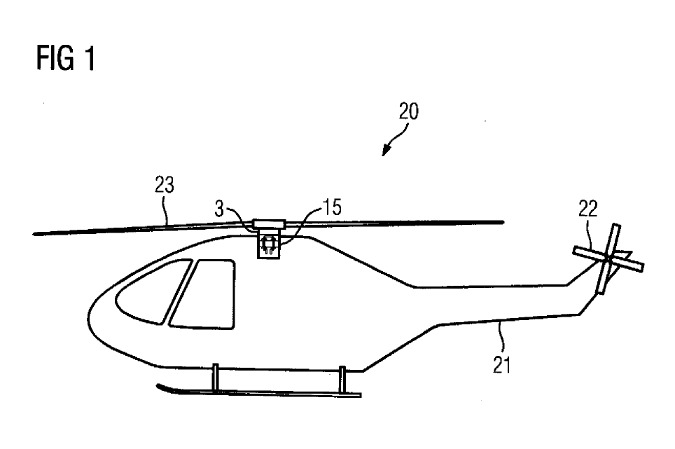

FIG. 1 shows a basic diagram of a helicopter,

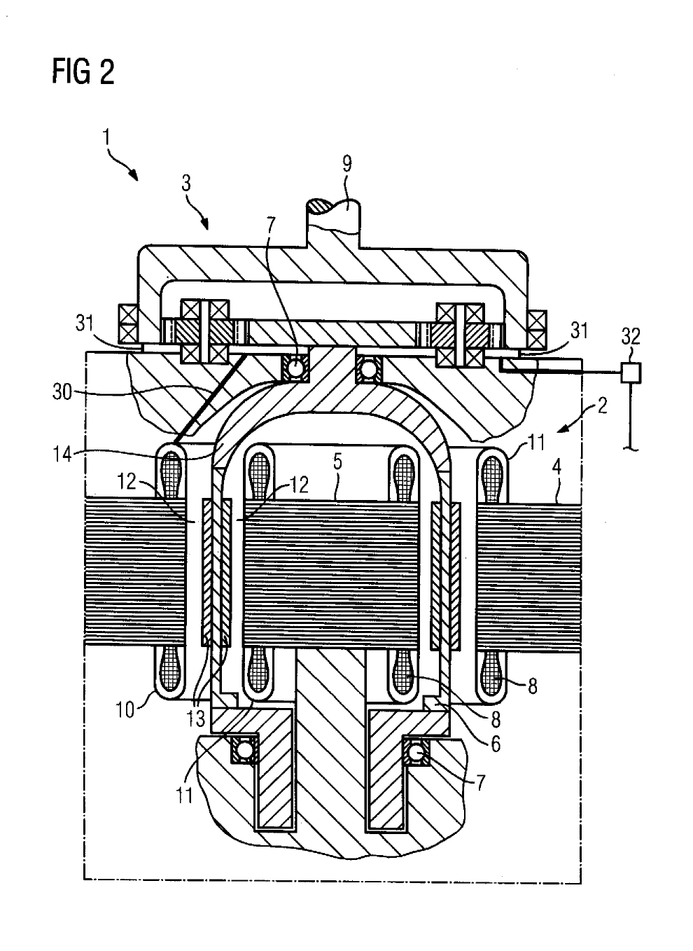

FIG. 2 shows a main rotor drive.

FIG. 1 shows a basic diagram of a helicopter 20 with a main rotor 23 and a tail rotor 22 which is attached to a tail section 21. “X” in this figure marks the section in which the drive 1 of the main rotor 23 is disposed.

FIG. 2 shows a basic longitudinal section of a drive 1 of a main rotor 23 of a helicopter 20. A rotor 6 of a vertically-mounted dynamoelectric machine 2 has permanent magnets 13 both on an inner side and also on an outer side of its carrier facility 14.

To enable the permanent magnets 13 to be held even with increased centrifugal forces, advantageously the permanent magnets are only disposed on the inner side of the support facility 14 of the rotor 6.

As an alternative to this the permanent magnets 13 are disposed on the inner side of the carrier facility 14, while the permanent magnets 13, which essentially interact with the external stator 4, are located on the outside of the carrier facility 14 in pockets running axially.

The permanent magnets 13 are each constructed in layers in order to reduce the eddy current losses. Furthermore the permanent magnets 13, viewed over their axial course of the rotor 6 are attached tapered and/or stepped in order to obtain a balancing out of the output torque of the drive.

These permanent magnets 13 interact with the winding system of the respective stator 4, 5 facing towards them, so that the drive 1 delivers a comparatively high torque. Via a planetary gear 3 disposed in an axial extension of the dynamo electric machine 2 a rotor of a helicopter not shown in any greater detail is driven via a rotor shaft 9.

As an alternative to a classical planetary gear comprising gear wheels, a gear with the same functionality, namely increasing the speed, is realized by permanent magnets. This avoids gear noise and there are no parts subject to wear to be maintained and replaced.

The inner stator 5 and also the outer stator 4 are stationary and each have a layered laminated core, preferably made of sandwich plates.

The carrier facility 14 of the rotor 6 is advantageously constructed from a number of parts, in that the magnetically-active part on which the permanent magnets 13 are disposed is embodied as a hollow cylinder. The number of poles of the sides facing towards the inner stator 5 and the outer stator 4 of the rotor 6 is preferably the same in such cases.

A support is provided for the rotor 6 in this case both on the side of the dynamoelectric machine 2 facing away from the drive 1 and also on the side facing towards the main rotor 23. The support between the dynamoelectric machine 2 and planetary gear 3 thus forms a common support of planetary gear 3 and dynamoelectric motor 2 in a duplex arrangement.

Preferably in this case dynamoelectric machine 2 and also planetary gear 3 are disposed in one housing. This simplifies the structure of the drive 1 and thus allows a final pre-fabrication of this drive 1.

To further increase the efficiency of the drive 1 both the inner and also the outer stator 4, 5 are oil-cooled. Consequently the air gap 12 of the dynamoelectric machine 2, in which the rotor 6 moves is also sealed off by suitable measures, for example by sealing measures such as a can 10, 11. At least the winding system with its winding heads 8 is enclosed and thus cooled by the can 10, 11.

In a further embodiment the can also encloses the laminated core of the stators 4, 5, winding head 8 and winding system.

An oil circuit not shown in any greater detail is advantageously at least partly routed via the planetary gear 3 and performs functions such as lubricating and cooling the gearwheels there.

To further reduce the air friction losses of the rotor 6 within the air gap 12 of the drive in the duplex arrangement a vacuum is preferably provided in the air gap 12.

With the described drive 1 a drive system is now created for a helicopter 20 with approximately 200 to 300 KW at approximately 2500 rpm at a specific power-to-weight ratio of approximately 8 KW/kg.

What is claimed is:

1.-8. (canceled)

9. An electric drive for an aircraft, comprising:
a dynamoelectric machine constructed in the form of a duplex arrangement and including a stator assembly demarcating an air gap, a rotor located in the air gap, and permanent magnets mounted to a carrier facility of the rotor, at least one of the stator assembly and the rotor being constructed for cooling thereof;
at least one rotor assembly driven directly by the dynamoelectric machine;
a planetary gear arranged between the rotor assembly and the dynamoelectric machine;
a common housing accommodating the dynamoelectric machine and the planetary gear; and
a common bearing disposed between the dynamoelectric machine and the planetary gear.

10. The electric drive of claim 9, wherein the aircraft is a helicopter.

11. The electric drive of claim 9, wherein the planetary gear is arranged in an axial extension of the dynamoelectric machine.

12. The electric drive of claim 9, wherein the carrier facility of the rotor comprises at least one member selected from the group consisting of soft iron and aramid.

13. The electric drive of claim 9, wherein the carrier facility of the rotor has a multipart construction.

14. The electric drive of claim 9, wherein the stator assembly has at least one stator having an oil circuit for cooling.

15. The electric drive of claim 14, wherein the stator assembly includes a winding, said oil circuit being configured to provide cooling of at least the winding of the stator assembly.

16. The electric drive of claim 14, wherein the oil circuit is configured to provide cooling of the at least one stator and the planetary gear.
